(19) United States
(12) Patent Application Publication
(10) Pub. No.: US 2006/0041416 A1
(43) Pub. Date: Feb. 23, 2006

(54) Circuit design simulation

(76) Inventors: Gaurav Rameshbhai Shah, Caldwell, ID (US); Denise Susan Man, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/920,576

(22) Filed: Aug. 18, 2004

(51) Int. Cl. G06F 17/50

(52) U.S. Cl. 703/14

(57) ABSTRACT

One example embodiment of an approach to circuit design simulation involves simulating a circuit design. Access to a circuit design block is provided for a plurality of simulation tools. A run status associated with the circuit design block is updated in response to the block being simulated by one of the plurality of simulation tools. In response to a first simulation tool request for access to information regarding a circuit design block, a run status of the block is checked, the run status being indicative of the block being simulated. The block is simulated as a function of the run status, and results of the simulation are returned to the simulation tool making the first simulation tool request.

### BACKGROUND

Circuit designs are generally created and implemented using tools that generate information that is stored in one or more data storage arrangements. Storing circuit design information typically involves storing information for each design component that identifies characteristics and connectivity for all components in the circuit design. For instance, many typical circuit designs employ a multitude of FETs (field-effect transistors) and NETs (information describing the connectivity of the FETs) that define functional circuits. These FETs and NETs are typically arranged with a hierarchical relationship, with different FETs and NETs being attributed to a multitude of blocks and sub-blocks (or child blocks) that characterize the circuit design.

Once circuit design information is stored, a multitude of simulation tools access the design information for simulation purposes (e.g., analysis and testing). For example, circuit recognition and verification are two approaches that involve access to stored design data for simulation purposes. Some of these simulation purposes include identifying components and connectivity for groups of circuit elements of a design (circuit recognition) and verifying the operation of the design under certain conditions (circuit verification). Typically, circuit design information is input in the form of a netlist, analyzed and its logical circuit classification is output. Simulation tools use this logical circuit classification in simulating operation of the logical circuit.

In many applications, simulation and testing of circuit designs is a relatively lengthy process involving many different individuals and testing arrangements. For example, as many as one hundred or more different tools often simultaneously access a circuit design for testing purposes. Various aspects of the simulation process involve redundant processing, such as that discussed above in connection with circuit recognition. For instance, when two different simulation tools are analyzing the same circuit design block, both tools need to use information typically generated with a circuit recognition approach. This redundant processing uses valuable processing capabilities and memory. In addition, as simulation is carried out on a circuit design, portions of the design are periodically updated. It is important to ensure that the most up-to-date information is used when simulating a circuit design block.

In simulating and testing circuit designs, it is also important to ensure that data being analyzed is correct and that results of the analysis are usable. In some applications, this involves ensuring that simulated design data is stored in a manner that is accessible by one or more simulation tools, and ensuring that the process of storing data is not subjected to corruption. For example, when a particular set of design data is simulated and stored in an extensible markup language (XML) data storage arrangement, tags are used to mark the beginning and end of the design data storage. Data is written in order such that data written between tags can be attributed to a particular set of design data. However, if two or more simulation runs are concurrently processed for the same particular set of design data, data corruption can occur when multiple tags are set for the set of design data and/or when repetitive data is written.

The above-discussed issues related to the simulation of circuit designs have presented challenges to the efficient simulation of circuit design data.

### SUMMARY

According to an example embodiment of the present invention, a circuit design simulation approach involves providing access to a circuit design block for a plurality of simulation tools. A run status associated with the circuit design block is updated in response to the block being simulated by one of the plurality of simulation tools. In response to a first simulation tool request for access to information regarding a circuit design block, a run status (indicative of the block being simulated) of the block is checked. The block is then simulated as a function of the run status. Results of the simulation are returned to the simulation tool making the first simulation tool request.

It will be appreciated that various other embodiments are set forth in the Detailed Description and Claims that follow.

### BRIEF DESCRIPTION OF THE DRAWINGS

FIG. 1 is a flow diagram for an approach to simulating a circuit design, according to an example embodiment of the present invention;

FIG. 2 shows a system for simulating a circuit design, according to another example embodiment of the present invention; and

FIG. 3 shows another flow diagram for simulating a circuit design, according to another example embodiment of the present invention.

### DETAILED DESCRIPTION

According to an example embodiment of the present invention, circuit design data is simulated as a function of simulation run status of the design data. When a component (e.g., a design block) of a circuit design is being simulated, access to the component for simulation purposes is generally restricted to the user (or tool) performing the simulation. In this regard, simultaneous simulation of a particular component of a circuit design is inhibited.

In another example embodiment of the present invention, a circuit simulation approach involves the use of a status indicator to characterize the simulation status of a particular circuit design block. When a simulation tool initiates a call for a design block, the status indicator is implemented to check whether the design block is being actively simulated. If the status indicator shows that the design block is being actively simulated, the simulation tool (or other processing circuitry) waits for the active simulation to finish. For instance, if the design block is being functionally classified or otherwise processed for use by another simulation tool, a subsequent call for the same block is effectively put on hold until the active simulation is complete. When the active simulation is complete, the results are returned to the simulation tool making the call that initiated the simulation of the block, as well as to the simulation tool (or tools) making the subsequent call.

If the status indictor does not show that the design block is being simulated, the simulation tool (or other processing circuitry) is allowed to access and simulate the design block data. In this instance, the status indicator is changed to indicate that the design block is being simulated. Subsequent calls to the same block during the simulation are correspondingly processed as discussed in the previous paragraph, using the results of the simulation being initiated here.

In some instances, the simulation results are stored in a location accessible by multiple simulation tools either directly or via a controller such that re-simulation of design blocks is not necessary. In this regard, if the status indicator does not show that a particular design block is being simulated, the storage location is checked for simulation results for the design block. Alternately, the storage location can be checked prior to checking the status indicator. In either instance, if simulation results for the design block are not in the storage location (and the design block is not being actively simulated), the block is simulated as discussed in the previous paragraph. If simulation results for the design block are in the storage location, the results are returned to the simulation tool making the call for the design block.

Depending upon the implementation, the status indicator is used in different manners to control or facilitate access to circuit design data (i.e., from a netlist). In some instances, the status indicator is used to prevent simultaneous access to design block information. For example, when a particular design block is being simulated in connection with a call from a particular simulation tool, no other simulation tool call is allowed access to the design block. In this regard, when simulation results map back to a particular design block and are being stored in a shared data location, the prevention of simultaneous runs is implemented to prevent different results from mapping to the same design block.

In other instances, the status indicator is used to prevent simulation access to a particular design block when the block is undergoing active simulation, but permits access for other purposes. For example, when a data storage location is used by more than one simulation tool for storing simulation data, it is often undesirable to inhibit the concurrent simulation of a particular design block. In this regard, access to design block information for simulation purposes is inhibited while access for other purposes (e.g., that do not involve the storage of simulation results in a shared data storage location) is allowed. This approach can be implemented, for example, where simulation results are stored separately for different simulation tool access or where access to the design block does not involve simulation susceptible to conflicting storage (and any related access issues).

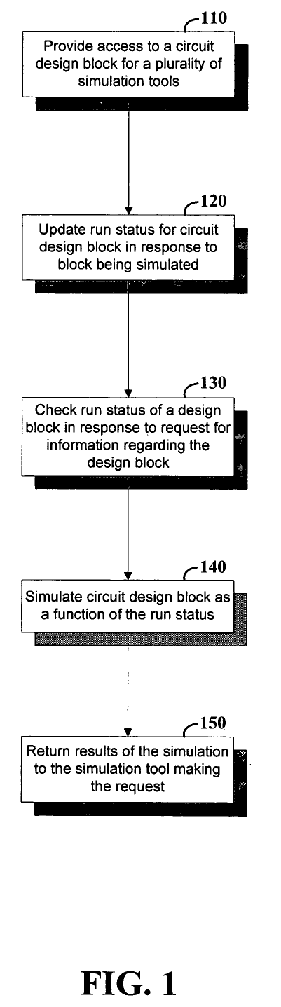

FIG. 1 shows a flow diagram for simulating a circuit design, according to another example embodiment of the present invention. At block 110, access is provided to a circuit design block for a plurality of simulation tools. At block 120, a run status associated with the circuit design block is updated in response to the block being simulated by one of the plurality of simulation tools. At block 130, a run status of the block is checked in response to a first simulation tool request for access to information regarding a circuit design block, with the run status being indicative of the block being simulated. The block is simulated as a function of the run status at block 140, and results of the simulation are returned to the simulation tool making the first simulation tool request at block 150.

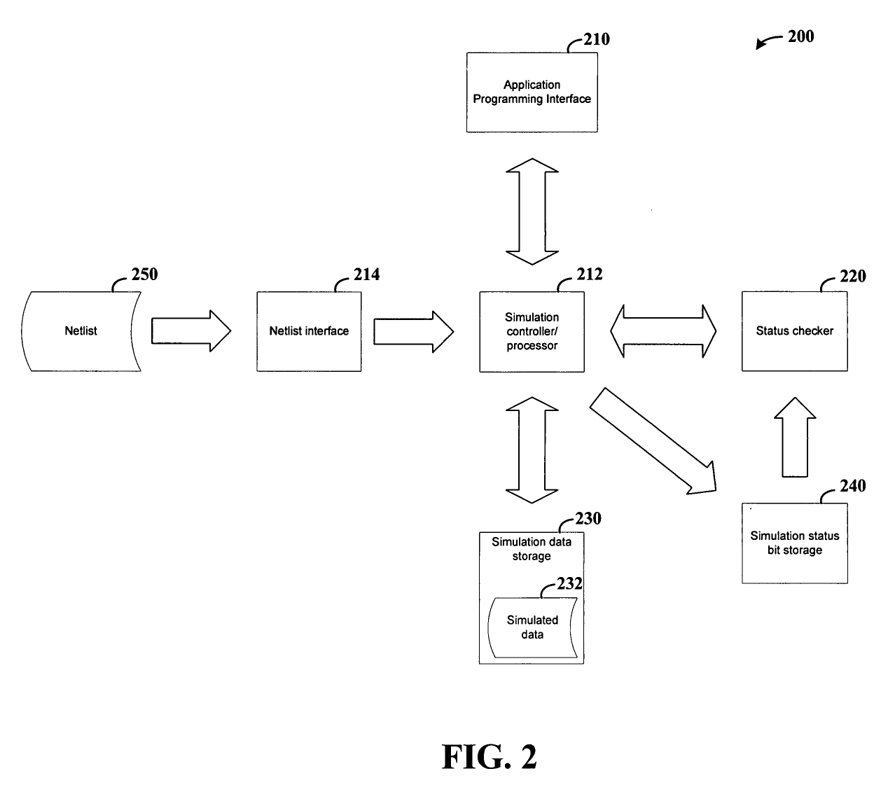

FIG. 2 shows an arrangement 200 for processing circuit design data, according to another example embodiment of the present invention. Some or all of the functionality of the arrangement 200 may be implemented using, for example, a program storage device with a processor and a processor-readable medium configured with instructions executable by the processor for demoting a page in virtual memory by performing the various functions (operations).

A controller/processor 212 facilitates the simulation and processing of circuit design data from a netlist 250 in response to application program calls from an Application Programming Interface (API) 210 (and from other API call sources, if applicable). The API 210 may be implemented, for example, with a simulation tool used for testing and analysis of blocks of the circuit design data, or with multiple such simulation tools. The controller/processor 212 is configured to retrieve circuit design blocks from the netlist 250 using a netlist adapter 214 and to simulate the retrieved circuit design blocks. Data storage arrangement 230 is adapted to store simulated data 232 generated by the controller/processor 212 and also to provide the stored data to the controller/processor 212 in response to subsequent API calls for the simulated data. Simulation status bit storage 240 stores status bits indicating that particular circuit design blocks are being actively simulated, and status checker 220 is adapted to check for the existence (and/or value) of the status bits.

The netlist 250 typically includes a hierarchical classification of the circuit design that includes blocks and nets, the blocks including one or more circuit elements and the nets describing the interconnection of the circuit elements and/or blocks. This hierarchical classification in the netlist 250 typically does not describe any grouping of the interconnected circuit elements that make up functional circuits (e.g., well-known circuits such as inverters, or customer-specific circuits). In this regard, the controller/processor 212 processes the circuit design block to functionally classify the block or components thereof. The functional classification describes functional characteristics of groups of circuit elements in the block when implemented together in a manner that is useful for simulating the circuit design block.

When an API call for a particular design block is received from the API 210, the controller/processor 212 checks the data storage arrangement 230 for simulated data 232 that corresponds to the design block requested by the API call. The design block may be specified in the API call using, for example, a design block identifier (e.g., name and path of a particular block of the design). If simulated data 232 does not include data that corresponds to the requested design block, the controller/processor 212 employs the status checker 220 to check simulation status bit storage 240. The check of the simulation status bit storage 240 facilitates a check to see if the data corresponding to the requested design block is being currently simulated (i.e., if a run status bit for the block is “TRUE”). If the status checker indicates to the controller/processor 212 that the requested design block is being simulated, the controller/processor waits until the simulation is complete, and returns the simulated data to the API 210.

If the status checker indicates to the controller/processor 212 that the requested design block data is not being simulated, the controller/processor 212 retrieves, via the netlist adapter 214, the requested design block from the netlist 250. The retrieved design block is simulated and, at the onset of the simulation, a simulation status bit is set to “TRUE” in the simulation status bit storage 240. The simulation result is returned to the API 210 and also stored in data storage arrangement 230, where it is made available for access in response to subsequent API calls. When a design block identifier is implemented as discussed above, the identifier can be used in storing the functional classification in the data storage arrangement 230, such that access to the functional classification data can be made via using the identifier to specify the data.

If simulated data 232 includes data that corresponds to the requested design block, the controller/processor 212 checks to see if the simulated data is up to date. For example, by checking a date stamp of the simulated data, relative to netlist information corresponding to the simulated data, the date status of simulated data can be ascertained. If the simulated data is up to date, it is returned to the API 210 initiating the API call (and, ultimately, to the simulation tool making the API call via the API 210, where applicable). If the simulation data is not up to date (i.e., a netlist contains data for the block that has a more recent date than the simulation data), the simulation data is replaced. For example, data can be simulated as discussed above, with the simulation status bit being set to “TRUE” for the block and the block being accessed from the netlist 250, simulated and stored in the data storage arrangement 230.

The simulation by the controller/processor 212 may be implemented with one or more of a variety of functions. In some instances, the simulation may involve a circuit recognition-type function in which characteristics of a circuit being simulated are identified for facilitating the simulation. For example, where a particular circuit design block is to be analyzed, the block is retrieved from the netlist 250 via netlist adapter 214 and can be partitioned into functional circuits that include a combination of circuit elements (e.g., a combination of FETs). These partitions are analyzed to determine a logical circuit classification (or classifications) that characterize the partition (i.e., the circuit type of the combination is recognized (circuit recognition)). These classifications include a functional description of the combination of individual circuit elements that function together to make a particular functional circuit. Various simulation functions, such as those implemented to determine circuit timing characteristics, circuit impedance and others can then be carried out using the circuit recognition results.

In some implementations, the controller/processor 212 monitors simulation for errors. If an error occurs, the controller/processor 212 resets a simulation status bit in simulation status bit storage 240 to indicate that the block under which an error occurred is not being actively simulated. An error bit can also be implemented to indicate that the simulation generated an error (this error bit may be stored, for example, with the simulation status bit storage 240). In addition, the controller/processor 212 can be further implemented to re-run simulation on the block undergoing simulation when the error occurred.

In some instances, the controller/processor 212 deletes some or all of the simulated data 232 generated during the simulation run that produced an error. For example, when an error affects some, but not all of generated simulation data, the controller/processor 212 does not remove unaffected data from the data storage arrangement 230. In this regard, when a design block having multiple sub-blocks is simulated, sub-blocks that have been simulated and that are unaffected by the error are maintained, saving re-simulation time.

The data storage arrangement 230 may be implemented using one or more of a variety of storage arrangements, such as an XML (extensible markup language) or SQL (structured query language) data storage arrangement. In addition, the data storage arrangement 230 can be implemented either locally at the controller/processor 212 or remotely, with access to the controller/processor 212 being via one or more of a variety of communication links. For instance, the controller/processor 212 may be coupled to network communications link, such as an Internet protocol (IP) link, with the controller/processor 212 as well as the data storage arrangement 230 being assigned addresses.

Referring again to FIG. 2, in some implementations, the above-discussed hierarchical relationship within a netlist involves “parent” and “child” blocks, the parent blocks being at a higher level than and including the child blocks. In this regard, when a particular block is checked for active simulation, active simulation of a parent block may affect the simulation status of a child block. For instance, if a parent block simulation is active but has already simulated the child block, simulation data for the child block can be made immediately available by the controller/processor 212 to the API 210. In addition, if a child block that is the subject of an API call is not being actively simulated but its parent block is being actively simulated, at least two courses of action can be taken. In some instances, the child block is immediately simulated and the results returned to the API 210 and also made available to the parent block simulation. In other instances, the parent block simulation is allowed to run its course and, when the child block is simulated as part of the parent block simulation, simulation data for the child block is returned to the API 210.

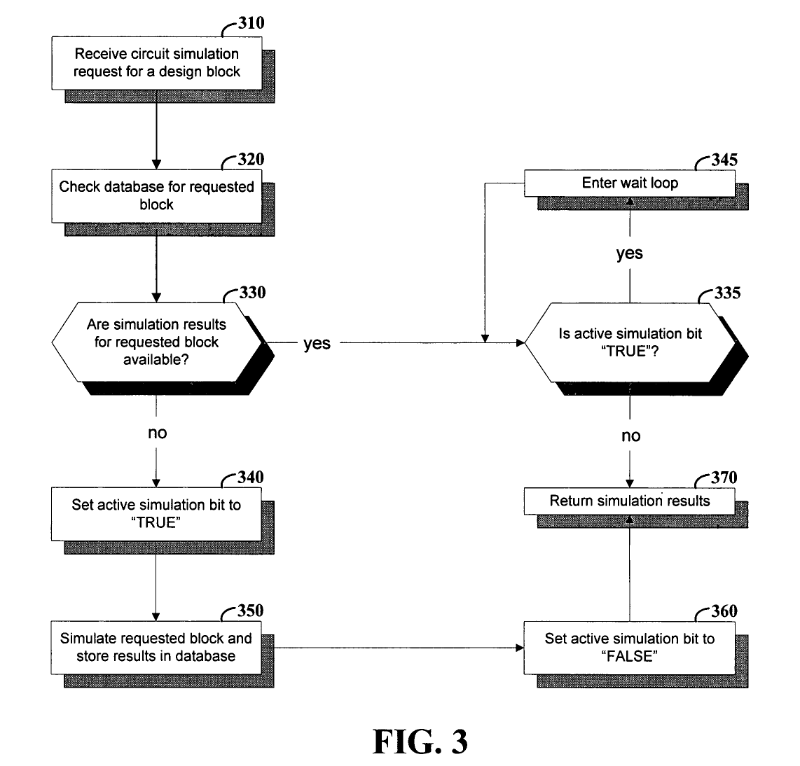

FIG. 3 shows a flow diagram for an approach to simulating a circuit design involving the re-use of circuit simulation data, according to another example embodiment of the present invention. The simulation process starts when a circuit simulation request for a particular design block is received at block 310. The request includes information that is sufficient for identifying the particular design block, such as the design block identifier discussed above. At block 320, a database (or other data storage arrangement) is checked for simulation results generated during a previous simulation run for the requested design block. If stored simulation results are available at block 330, the stored results can be used to respond to the circuit simulation request. If an active simulation bit is not “TRUE” at block 335 (the requested design block is not being actively simulated), the stored simulation results are returned to the entity requesting the design block at block 370.

If stored simulation results are available at block 330, but an active simulation bit is “TRUE” at block 335 (the requested design block is being actively simulated), the process enters a wait loop at block 345. In the wait loop, the active simulation bit is recurrently (e.g., periodically) checked at block 335. When the simulation is complete, a controller or other circuit resets the simulation bit such that it is no longer “TRUE.” This change in bit status is detected in the wait loop after the active simulation bit is no longer “TRUE” and the stored simulation results are returned to the entity requesting the design block 370.

In some implementations, the wait loop is carried out passively at block 345, with a simulation controller or other circuit generating a notification upon completion of the simulation run for the requested design block. Referring to FIG. 2 as an example, the controller/processor 212 can be programmed to automatically generate a signal in response to a simulation run being completed. This signal can be used to initiate the return of the simulation data to the entity making the circuit simulation request at block 310. In some instances, the controller/processor 212 not only resets a status bit in simulation status bit storage after a simulation run is complete, it also generates a simulation completion signal as discussed above. Alternately, the status checker 220 can be programmed to monitor the status of the simulation status bit storage 240 and to generate a signal in response to a simulation run being completed. In either of these examples, either the actual completion of the simulation run, or the value of a status bit in the simulation status bit storage 240, may be used for detecting the completion of a simulation run.

If simulation results for the requested block are not available at block 330, an active simulation bit is set to “TRUE” at block 340. The requested block is simulated at block 350 and the results of the simulation are stored in a database. After the simulation is complete, the active simulation bit is set to “FALSE” at block 360 and the simulation results are returned to the entity making the circuit simulation request received at block 310. In some instances, setting the active simulation bit to “FALSE” at block 360 further includes generating a notification that the simulation is complete, where the wait loop at block 345 is passive as discussed above.

Referring again to FIG. 3, if the simulation requested at block 310 is for a design block having multiple sub-blocks, simulation is addressed separately for each of the sub-blocks. For example, at block 320, the database is checked for simulation results for all of the sub-blocks. If simulation results for some, but not all, of the sub-blocks are available at block 330, the flow for sub-blocks having or not having available simulation results proceed respectively to blocks 335 and 340. In this regard, simulation is carried out only for those sub-blocks that have not been previously simulated.

In addition, when multiple sub-blocks need to be simulated and that simulation is carried out over time, the check at blocks 330 and 335 are made prior to each simulation. In this regard, changes in simulation result availability or in active simulation bit status (e.g., in response to another simulation request) are addressed as the simulation progresses, facilitating the avoidance of simulation conflicts and redundant block processing.

For general information regarding circuit simulation, and for specific information regarding approaches to circuit simulation involving the re-use of simulation data, reference may be made to U.S. Provisional Patent Application Ser. No. 60/569411, filed May 7, 2004, which is fully incorporated herein by reference. For instance, the various examples, approaches and implementations discussed above in connection with the figures and otherwise may implement the devices and approaches discussed in the above-referenced patent document.

Those skilled in the art will appreciate that various alternative computing arrangements would be suitable for hosting the approaches of the different embodiments of the present invention. In addition, the approaches may be implemented via a variety of computer-readable media or delivery channels such as magnetic or optical disks or tapes, electronic storage devices, or as application services over a network.

The present invention is believed to be applicable to a variety of circuit design simulation arrangements and approaches and has been found to be particularly applicable and beneficial for use with circuit design data simulation for use with circuit recognition and verification-type implementations. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A method for simulating a circuit design, the method comprising:
providing access to a circuit design block for a plurality of simulation tools;
updating a run status associated with the circuit design block in response to the block being simulated by one of the plurality of simulation tools;
in response to a first simulation tool request for access to information regarding a circuit design block, checking a run status of the block, the run status being indicative of the block being simulated;
simulating the block as a function of the run status; and
returning results of the simulation to the simulation tool making the first simulation tool request.

2. The method of claim 1, wherein simulating the block as a function of the run status includes, in response to the run status indicating that the block is being simulated, using the results of the block simulation.

3. The method of claim 2, wherein using the results of the block simulation includes monitoring the run status and, when the run status indicates that the block simulation is complete, using the completed results of the block simulation.

4. The method of claim 1, wherein simulating the block as a function of the run status includes, in response to the run status indicating that the block is being simulated, simulating the block after the indicated block simulation is complete.

5. The method of claim 4, wherein simulating the block after the indicated block simulation is complete includes entering a wait loop that checks the run status in a loop function and, in response to the run status changing to indicate that the block is no longer being simulated, exiting the wait loop and simulating the block.

6. The method of claim 4, wherein simulating the block after the indicated block simulation is complete includes simulating the block in response to receiving an signal indicating that the indicated block simulation is complete.

7. The method of claim 1, wherein simulating the block as a function of the run status includes simulating the block in response to the run status indicating that the block is not being simulated.

8. The method of claim 7, further comprising setting a run status of the block to indicate that the block is being simulated.

9. The method of claim 7, further comprising storing the results of the simulation in a data storage arrangement accessible by simulation tools.

10. The method of claim 1, wherein simulating the block as a function of the run status includes:
in response to the run status indicating that the block is not being simulated, checking a data storage location for simulation results for the block;
in response to simulation results for the block being in the data storage location, using the simulation results; and
in response to simulation results for the block being in the data storage location, simulating the block.

11. The method of claim 10, wherein using the simulation results includes:
comparing a date stamp of the simulation results in the data source with a date stamp of a corresponding block in a netlist;
if the date stamp of the block in the data source is older than the date stamp of the corresponding block in the netlist, re-simulate the block and use the re-simulated results; and
if the date stamp of the block in the data source is not older than the date stamp of the corresponding block in the netlist, use the simulation results in the data source.

12. The method of claim 1, further comprising, in response to detecting an error in a simulation run for a circuit design block, stopping the simulation run and setting the run status to indicate that the circuit design block is not being simulated.

13. The method of claim 12, further comprising erasing simulation data generated during the simulation run during which the error is detected.

14. The method of claim 12, further comprising, in response to detecting the error, setting an error status to indicate that an error was detected.

15. The method of claim 1, further comprising, in response to detecting an error in a simulation run for a circuit design block, pausing the simulation run, correcting the error and resuming the simulation run while maintaining the run status to indicate that the circuit design block is being simulated.

16. The method of claim 1, wherein checking a run status of the block includes checking a run status of a child block by checking the run status of a parent block that includes the child block.

17. The method of claim 16, wherein simulating the block as a function of the run status includes simulating a child block for which the parent block is being simulated and, during the simulation of the child block, updating a run status associated with the child block to indicate that the child block is being actively simulated.

18. The method of claim 1, wherein checking a run status of the block includes checking a run status of a parent block by checking the run status of a child block that is part of the parent block.

19. The method of claim 18, wherein simulating the block as a function of the run status includes simulating the parent block while the run status of the child block indicates that the child block is being simulated, wherein simulating the parent block does not include simulating the child block indicated as being simulated, and wherein returning the results of the simulation includes returning results of the child block simulation and the parent block simulation.

20. The method of claim 18, wherein simulating the block as a function of the run status includes, in response to the run status indicating that the child block is being simulated, waiting until the run status changes to indicate that the child block is not being simulated and, thereafter, simulating the parent block.

21. The method of claim 1, wherein simulating the block as a function of the run status includes simulating the block using read-only access to the circuit design block in response to the run status indicating that the block is being simulated.

22. The method of claim 1, wherein simulating the block as a function of the run status includes, in response to the run status indicating that the block has been simulated, converting information from results of the indicated simulation for use by a particular simulation tool.

23. A system for simulating a circuit design, the system comprising:
means for providing access to a circuit design block for a plurality of simulation tools;
means for updating a run status associated with the circuit design block in response to the block being simulated by one of the plurality of simulation tools;
means, responsive to a first simulation tool request for access to information regarding a circuit design block, for checking a run status of the block, the run status being indicative of the block being simulated;
means for simulating the block as a function of the run status; and
means for returning results of the simulation to the simulation tool.

24. A system for simulating a circuit design, the system comprising:
an interface arrangement adapted to:
provide access to a circuit design block for a plurality of simulation tools;
update a run status associated with the circuit design block in response to the block being simulated by one of the plurality of simulation tools;
in response to a first simulation tool request for access to information regarding a circuit design block, check a run status of the block, the run status being indicative of the block being simulated;
simulate the block as a function of the run status; and
return results of the simulation to the simulation tool.

25. The system of claim 24, further comprising:
a communications link between the interface arrangement and the plurality of simulation tools; and
a data storage arrangement adapted to store circuit design block data, wherein the interface arrangement is adapted to simulate the block by retrieving the stored design block data for the block from the data storage arrangement.

26. A program storage device, comprising:
a processor;
a processor-readable medium configured with instructions executable by the processor for demoting a page in virtual memory by performing the operations of:
providing access to a circuit design block for a plurality of simulation tools;
updating a run status associated with the circuit design block in response to the block being simulated by one of the plurality of simulation tools;
in response to a first simulation tool request for access to information regarding a circuit design block, checking a run status of the block, the run status being indicative of the block being simulated;
simulating the block as a function of the run status; and
returning results of the simulation to the simulation tool making the first simulation tool request.

27. The device of claim 26, wherein the processor-readable medium is further configured with instructions executable by the processor for demoting a page in virtual memory by performing the operations of simulating the block as a function of the run status by, in response to the run status indicating that the block is being simulated, using the results of the block simulation.

28. The device of claim 27, wherein the processor-readable medium is further configured with instructions executable by the processor for demoting a page in virtual memory for using the results of the block simulation by monitoring the run status and, when the run status indicates that the block simulation is complete, by using the completed results of the block simulation.

29. The device of claim 26, wherein the processor-readable medium is further configured with instructions executable by the processor for demoting a page in virtual memory for simulating the block as a function of the run status by, in response to the run status indicating that the block is being simulated, simulating the block after the indicated block simulation is complete.

30. The device of claim 29, wherein the processor-readable medium is further configured with instructions executable by the processor for demoting a page in virtual memory for simulating the block after the indicated block simulation is complete by entering a wait loop that checks the run status in a loop function and, in response to the run status changing to indicate that the block is no longer being simulated, exiting the wait loop and simulating the block.

31. The device of claim 29, wherein the processor-readable medium is further configured with instructions executable by the processor for demoting a page in virtual memory for simulating the block after the indicated block simulation is complete by simulating the block in response to receiving a signal indicating that the indicated block simulation is complete.

32. The device of claim 26, wherein the processor-readable medium is further configured with instructions executable by the processor for demoting a page in virtual memory for simulating the block as a function of the run status by simulating the block in response to the run status indicating that the block is not being simulated.

33. The device of claim 32, wherein the processor-readable medium is further configured with instructions executable by the processor for demoting a page in virtual memory by setting a run status of the block to indicate that the block is being simulated.

34. The device of claim 32, wherein the processor-readable medium is further configured with instructions executable by the processor for demoting a page in virtual memory by storing the results of the simulation in a data storage arrangement accessible by simulation tools.

35. The device of claim 26, wherein the processor-readable medium is further configured with instructions executable by the processor for demoting a page in virtual memory for simulating the block as a function of the run status by:
in response to the run status indicating that the block is not being simulated, checking a data storage location for simulation results for the block;
in response to simulation results for the block being in the data storage location, using the simulation results; and
in response to simulation results for the block being in the data storage location, simulating the block.

36. The device of claim 35, wherein the processor-readable medium is further configured with instructions executable by the processor for demoting a page in virtual memory for using the simulation results by:
comparing a date stamp of the simulation results in the data source with a date stamp of a corresponding block in a netlist;
if the date stamp of the block in the data source is older than the date stamp of the corresponding block in the netlist, re-simulating the block and use the re-simulated results; and
if the date stamp of the block in the data source is not older than the date stamp of the corresponding block in the netlist, using the simulation results in the data source.

37. The device of claim 26, wherein the processor-readable medium is further configured with instructions executable by the processor for demoting a page in virtual memory by, in response to detecting an error in a simulation run for a circuit design block, stopping the simulation run and setting the run status to indicate that the circuit design block is not being simulated.

38. The device of claim 37, wherein the processor-readable medium is further configured with instructions executable by the processor for demoting a page in virtual memory by erasing simulation data generated during the simulation run during which the error is detected.

39. The device of claim 37, wherein the processor-readable medium is further configured with instructions executable by the processor for demoting a page in virtual memory by, in response to detecting the error, setting an error status to indicate that an error was detected.

40. The device of claim 26, wherein the processor-readable medium is further configured with instructions executable by the processor for demoting a page in virtual memory by, in response to detecting an error in a simulation run for a circuit design block, pausing the simulation run, correcting the error and resuming the simulation run while maintaining the run status to indicate that the circuit design block is being simulated.

41. The device of claim 26, wherein the processor-readable medium is further configured with instructions executable by the processor for demoting a page in virtual memory for checking a run status of the block by checking a run status of a child block by checking the run status of a parent block that includes the child block.

42. The device of claim 41, wherein the processor-readable medium is further configured with instructions executable by the processor for demoting a page in virtual memory for simulating the block as a function of the run status by simulating a child block for which the parent block is being simulated and, during the simulation of the child block, updating a run status associated with the child block to indicate that the child block is being actively simulated.

43. The device of claim 26, wherein the processor-readable medium is further configured with instructions executable by the processor for demoting a page in virtual memory for checking a run status of the block by checking a run status of a parent block by checking the run status of a child block that is part of the parent block.

44. The device of claim 43, wherein the processor-readable medium is further configured with instructions executable by the processor for demoting a page in virtual memory for simulating the block as a function of the run status by simulating the parent block while the run status of the child block indicates that the child block is being simulated, for simulating the parent block by not simulating the child block indicated as being simulated, and for returning the results of the simulation by returning results of the child block simulation and the parent block simulation.

45. The device of claim 43, wherein the processor-readable medium is further configured with instructions executable by the processor for demoting a page in virtual memory for simulating the block as a function of the run status by, in response to the run status indicating that the child block is being simulated, waiting until the run status changes to indicate that the child block is not being simulated and, thereafter, simulating the parent block.

46. The device of claim 26, wherein the processor-readable medium is further configured with instructions executable by the processor for demoting a page in virtual memory for simulating the block as a function of the run status by simulating the block using read-only access to the circuit design block in response to the run status indicating that the block is being simulated.

47. The device of claim 26, wherein the processor-readable medium is further configured with instructions executable by the processor for demoting a page in virtual memory for simulating the block as a function of the run status by, in response to the run status indicating that the block has been simulated, converting information from results of the indicated simulation for use by a particular simulation tool.
